(19) United States
(12) Patent Application Publication
(10) Pub. No.: US 2011/0074568 A1
(43) Pub. Date: Mar. 31, 2011

(54) WIRELESS BRAKE LIGHT APPARATUS

(76) Inventor: Johnson Li, Taichung Hsien (TW)

(21) Appl. No.: 12/568,682

(22) Filed: Sep. 29, 2009

(51) Int. Cl. B60Q 1/44

(52) U.S. Cl. 340/479

(57) ABSTRACT

A wireless brake light apparatus includes a brake device adapting to be connected to a handlebar of a bicycle. The brake device comprises a brake lever. A clamping member is detachably connected to the brake device. An actuator is adjustably connected to the clamping member and located beside the brake lever. The actuator has a detector disposed thereon and facing the brake lever. At least one lighting device adapts to be mounted on the bicycle and wirelessly communicated with the detector. When braking, the brake lever is simultaneously slightly moved to contact with the detector. The detector is actuated to send a radio frequency signal to the at least one lighting device for providing illumination.

### BACKGROUND OF THE INVENTION

1. Field of the Invention

The present invention relates to a wireless brake light apparatus, and more particularly to a brake light apparatus which provides illumination by wireless communication and is easily detached/assembled.

2. Description of Related Art

A conventional bicycle handlebar with an illuminating device in accordance with the prior art comprises a handlebar having a control switch disposed on an outer periphery thereof. The handlebar is hollow. An illuminating device is mounted on one end of the handlebar for providing illumination. The illuminating device includes a control circuit mounted thereon for controlling blinking light. The control circuit has an automatic turn-off function. A signal cable is received in the handlebar. The signal cable has two ends respectively electrically connected to the control circuit and the control switch. Therefore, when a rider turns on the switch, the illuminating device emits blinking light for providing an alert.

However, the conventional bicycle handlebar with an illuminating device suffered from several disadvantages. The control cable is easily unintentionally pulled or dragged if the control cable is not installed well. It may cause a bad communication between the switch and the illuminating device. When the rider brakes the bicycle, it is inconvenient that the rider has to switch on the illuminating device to provide a blinking alert light.

The present invention has arisen to mitigate and/or obviate the disadvantages of the conventional bicycle handlebar with an illuminating device.

### SUMMARY OF THE INVENTION

The main objective of the present invention is to provide an improved wireless brake light apparatus.

To achieve the objective, the wireless brake light apparatus in accordance with the present invention includes a brake device adapting to be connected to a handlebar of a bicycle. The brake device comprises a brake lever having a first end pivotally movably located beside the handlebar. A clamping member is detachably connected to the brake device. The clamping member has an elastic clamp formed thereon for detachably clamping on the brake device. The clamping member has a positioning portion on one end thereof. The positioning portion has a spring and a ball received therein. The clamping member includes a bolt movably connected to the positioning portion. The bolt has a recess defined in a first side thereof and two series of second teeth formed on the first side thereof. The two series of second teeth oppositely located beside the recess. The bolt has at least one positioning hole defined in a second side thereof opposite to the first side. The spring urges the ball to engage with the positioning hole for limiting a movement of the bolt.

The wireless brake light apparatus further comprises an actuator adjustably rotatably connected to the clamping member and located beside a second end of the brake lever opposite to the first end. The actuator has a detector disposed on one side thereof and facing the second end of the brake lever. The actuator has an engaging portion formed on one end thereof and pivotally connecting with the positioning portion. The engaging portion has a series of first teeth extending therefrom for engaging with the bolt and restraining a movement of the actuator.

Additionally, at least one lighting device adapts to be mounted on the bicycle and wirelessly communicates with the detector via radio frequency identification (RFID).

Accordingly, when the first teeth are received in the recess in the bolt, the actuator is free to be adjusted close to brake lever. When the first teeth engage with any one of the two series of second teeth and the spring urges the ball to engage with the positioning hole in the bolt, the actuator is locked. When braking, the first end of the brake lever is pivotally moved to the handle bar. The second end of the brake lever is simultaneously slightly moved to contact with the detector, such that the detector is actuated to send a radio frequency signal to the at least one lighting device for providing illumination.

In accordance with a second aspect of the present invention, the clamping member has a C-shaped holder formed on one end thereof opposite to the positioning portion for detachably holding on the handlebar.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a preferred embodiment of a wireless brake light apparatus in accordance with the present invention;

FIG. 2 is an assembled perspective view of the preferred embodiment of the wireless brake light apparatus in accordance with the present invention;

FIG. 3 is a partial cross-sectional plane view of the preferred embodiment of an engagement of an actuator and a positioning portion of the wireless brake light apparatus in accordance with the present invention;

FIGS. 4-5 are operational plane views of the preferred embodiment of the wireless brake light apparatus in accordance with the present invention when braking;

FIG. 6 is a perspective view of the preferred embodiment of the wireless brake light apparatus assembled on a bicycle in accordance with the present invention;

FIGS. 7-8 are respectively a side and a top views of the preferred embodiment of the wireless brake light apparatus assembled on the bicycle in accordance with the present invention when braking; and

FIG. 9 is a perspective view of a second embodiment of the clamping member of the wireless brake light apparatus in accordance with the present invention.

### DETAILED DESCRIPTION OF THE INVENTION

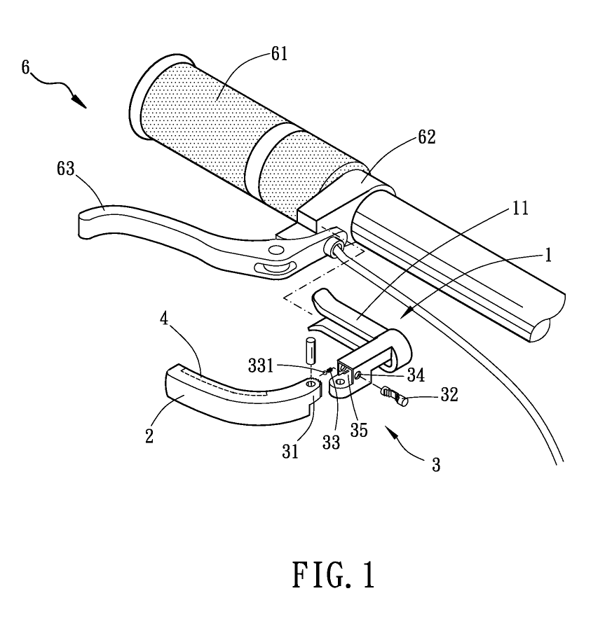

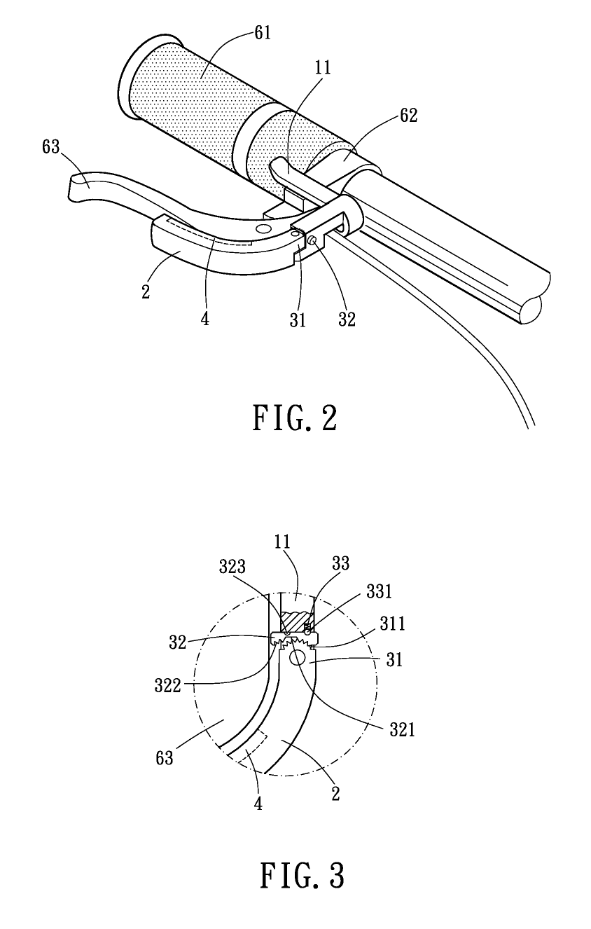

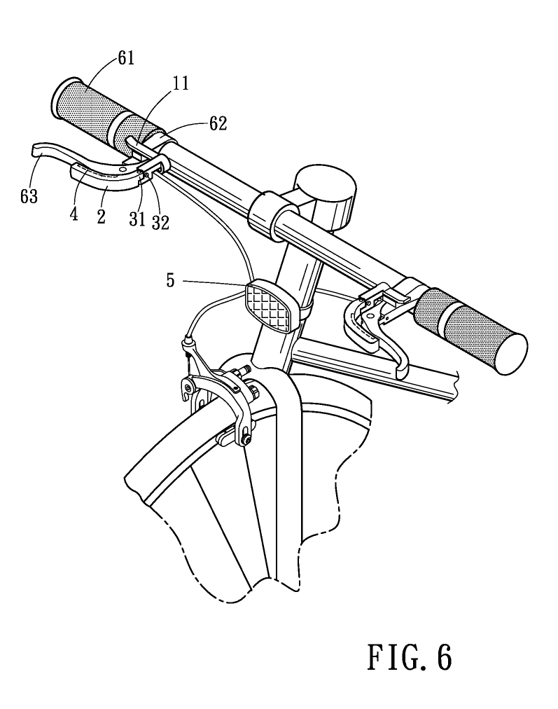

Referring to the drawings and initially to FIGS. 1-5, a wireless brake light apparatus in accordance with the present invention comprises a brake device 6 adapting to be connected to a handlebar 61 of a bicycle. The brake device 6 comprises a fastener 62 detachably connected to one end of the handlebar 61 and a brake lever 63 having a second end pivotally connected to the fastener 62. When the brake lever 63 pivotally rotates relative to the handlebar 61, a first end of the brake lever 63 opposite to the second end is pivotally moved toward the handlebar 61.

A clamping member 1 is detachably connected to the brake device 6. The clamping member 1 has an elastic clamp 11 laterally formed thereon thereof for detachably clamping on the fastener 62 of the brake device 6. The clamping member 1 has a positioning portion 3 formed on one end thereof. The positioning portion 3 has a receiving hole 35 defined therein and has two holes 34 defined in two opposite lateral sides thereof. The positioning portion 3 has a spring 33 and a ball 331 received in the receiving hole 35. The spring 33 has two ends respectively abutting against a bottom of the receiving hole 35 and the ball 331.

Moreover, the positioning portion 3 includes a bolt 32 movably passing through the two holes 34 and received in the receiving hole 35. The bolt 32 has a recess 321 defined in a centre of a first side thereof. The bolt 32 has two series of second teeth 322 respectively formed on two ends of the first side thereof and oppositely located beside the recess 321. The bolt 32 has at least one positioning hole 323 defined in a second side thereof opposite to the first side. The spring 33 urges the ball 331 to engage with the at least one positioning hole 323 for limiting a movement of the bolt 32.

The wireless brake light apparatus further comprises an actuator 2 adjustably pivotally connected to the clamping member 1 and located beside the second end of the brake lever 63 opposite to the first end. The actuator 2 has a detector 4 disposed on one side thereof and facing the second end of the brake lever 63. The actuator 2 has an engaging portion 31 formed on one end thereof for pivotally rotatably connecting to the positioning portion 3. The engaging portion 31 has a series of first teeth 311 extending therefrom for engaging with the bolt 32 in the receiving hole 35.

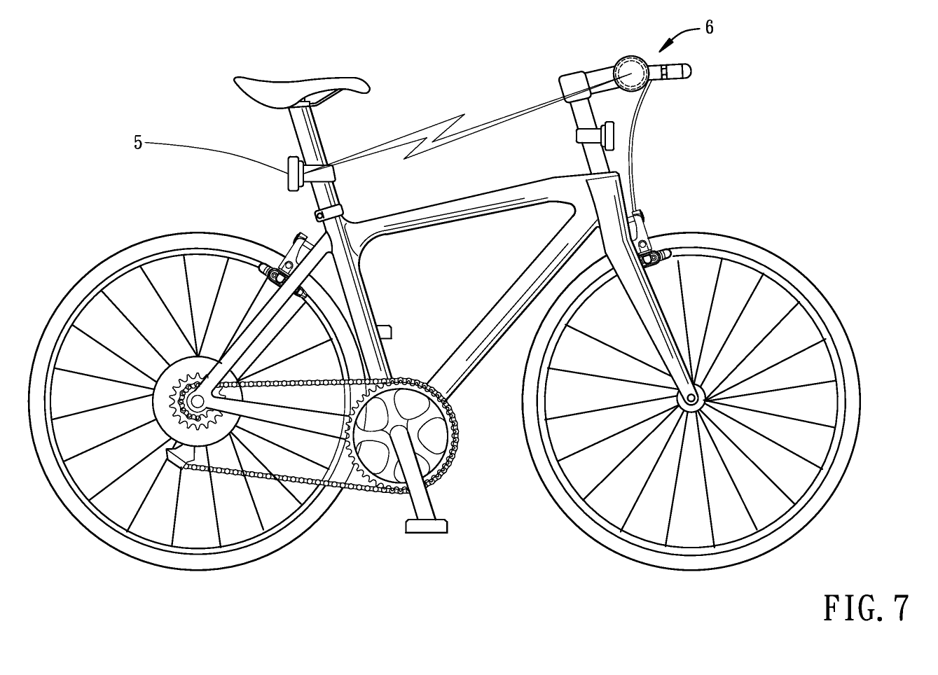

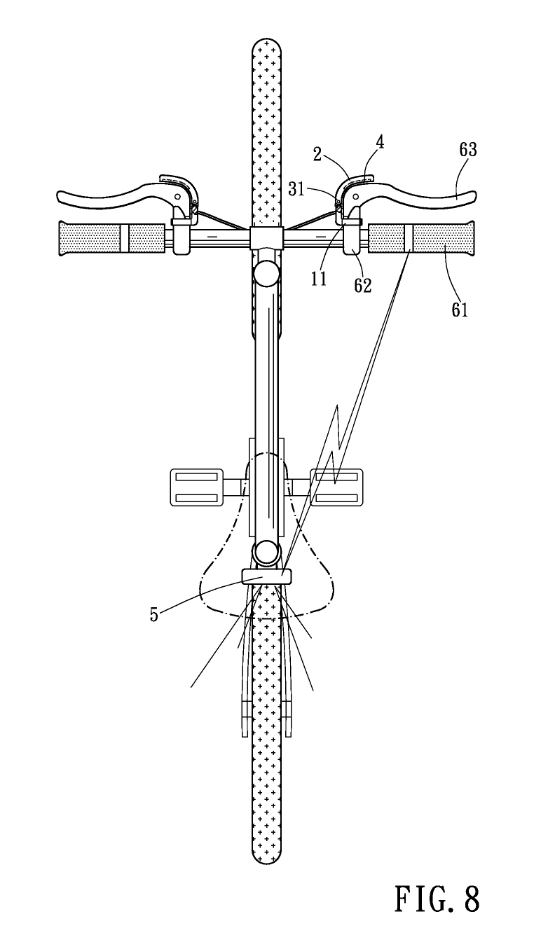

As shown in FIGS. 6-8, at least one lighting device 5 adapts to be mounted on a head tube (not numbered) or a seat tube (not numbered) of the bicycle. The at least one lighting device 5 wirelessly communicates with the detector 4 via radio frequency identification (RFID). The present invention applies RFID technology for wireless communication. How the RFID works in the present invention is not described

Accordingly, when the first teeth 311 are received in the recess 321 in the bolt 32, the ball 331 is retracted to disengage with the at least one positioning hole 323. The actuator 2 is free to pivotally rotate relative to the clamping member 1.

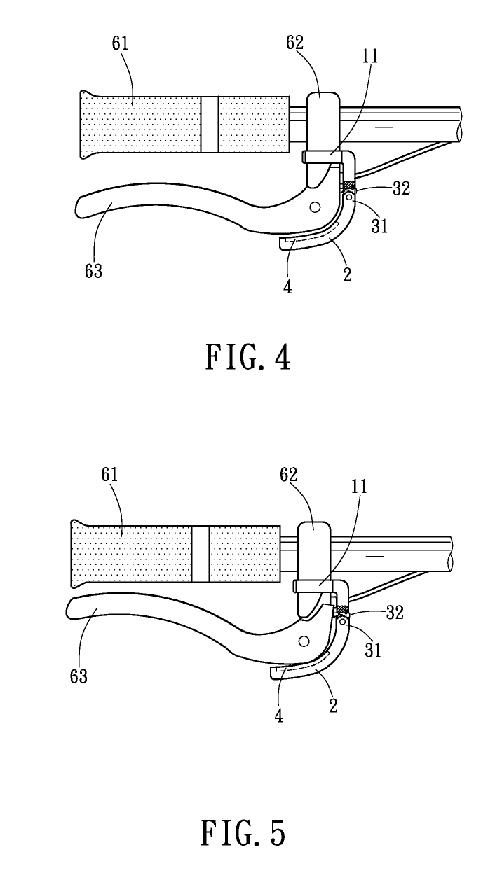

Referring to FIG. 3, when the detector 4 is adjusted close to the second end of brake lever 63, the bolt 32 is laterally pushed such that the first teeth 311 engage with any one of the two series of second teeth 322 for restraining a movement of the actuator 2. The spring 33 urges the ball 331 to engage with the positioning hole 323 in the bolt 32. The actuator 2 is locked.

When the first end of the brake lever 63 is pivotally moved to the handle bar 61, the second end of the brake lever 63 is simultaneously slightly moved to contact with the detector 4, such that the detector 4 is actuated to send a radio frequency signal to drive the at least one lighting device 5. The at least one lighting device 5 receives the radio frequency signal to provide illumination for a braking alert.

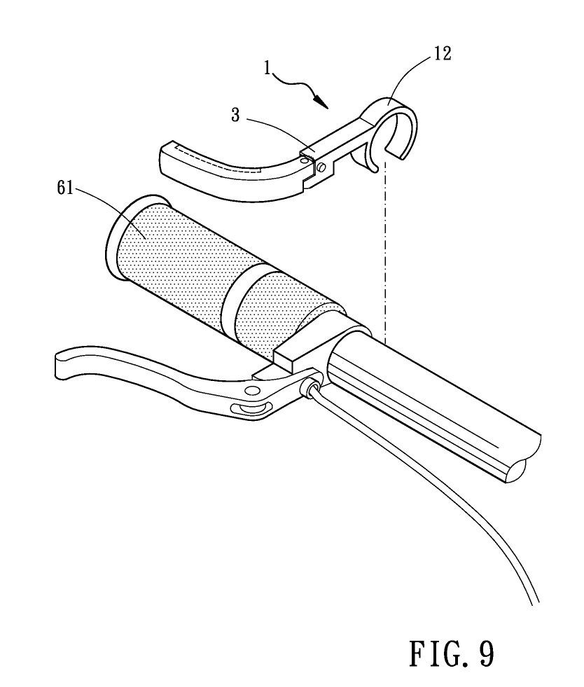

With reference to FIG. 9, that shows a second embodiment of the wireless brake light apparatus in accordance with the present invention. The elements and effects of the second embodiment which are the same with the first embodiment are not described, only the differences are described. In this embodiment, the clamping member 1 has a C-shaped holder 12 formed on one end thereof opposite to the positioning portion 3 for detachably holding on the handlebar 61.

Although the invention has been explained in relation to its preferred embodiment, it is to be understood that many other possible modifications and variations can be made without departing from the spirit and scope of the invention as hereinafter claimed.

What is claimed is:

1. A wireless brake light apparatus comprising:
a brake device adapting to be connected to a handlebar of a bicycle, the brake device comprising a brake lever having a first end pivotally movably located beside the handlebar;
a clamping member detachably connected to the brake device;
an actuator adjustably connected to the clamping member and located beside a second end of the brake lever opposite to the first end, the actuator having a detector disposed on one side thereof and facing the second end of the brake lever; and
at least one lighting device adapting to be mounted on the bicycle and wirelessly communicating with the detector;
wherein when the first end of the brake lever is pivotally moved toward the handle bar, the second end of the brake lever is simultaneously slightly moved to contact with the detector, such that the detector is actuated to send a signal to drive the at least one lighting device for providing illumination.

2. The wireless brake light apparatus as claimed in claim 1, wherein the detector wirelessly communicates with the at least one light device via radio frequency identification (RFID).

3. The wireless brake light apparatus as claimed in claim 1, wherein the actuator has an engaging portion formed on one end thereof, the engaging portion having a series of first teeth extending therefrom, the clamping member having a positioning portion formed on one end thereof and pivotally connected to the engaging portion, the positioning portion having a spring and a ball received therein, the clamping member including a bolt movably connected to the positioning portion, the bolt having a recess defined in a first side thereof, the bolt having two series of second teeth respectively formed on two ends of the first side thereof, the two series of second teeth oppositely located beside the recess for restraining a movement of the actuator, the bolt having at least one positioning hole defined in a second side thereof opposite to the first side, the spring urging the ball to engage with the positioning hole for limiting a movement of the bolt;
wherein when the first teeth are received in the recess in the bolt, the actuator is freely adjusted close to brake lever; when the first teeth engage with any one of the two series of second teeth and the spring urges the ball to engage with the positioning hole in the bolt, the actuator is locked.

4. The wireless brake light apparatus as claimed in claim 1, wherein the clamping member has an elastic clamp formed thereon for detachably clamping on the brake device.

5. The wireless brake light apparatus as claimed in claim 1, wherein the clamping member has a C-shaped holder formed on the other end thereof opposite to the positioning portion for detachably holding on the handlebar.
